(19) United States
(12) Patent Application Publication
(10) Pub. No.: US 2013/0047673 A1
(43) Pub. Date: Feb. 28, 2013

(54) Glass Tempering Method And Apparatus

(71) Applicants: Hoikwan Lee, ChungCheongNam-Do (KR); Kyungmin Yoon, ChungCheongNam-Do (KR); Seo-Yeong Cho, ChungCheongNam-Do (KR); YoonYoung Kwon, ChungCheongNam-Do (KR); Jinsu Nam, ChungCheongNam-Do (KR); Kyungwook Park, ChungCheongNam-Do (KR); Jaeyoung Choi, ChungCheongNam-Do (KR)

(72) Inventors: Hoikwan Lee, ChungCheongNam-Do (KR); Kyungmin Yoon, ChungCheongNam-Do (KR); Seo-Yeong Cho, ChungCheongNam-Do (KR); YoonYoung Kwon, ChungCheongNam-Do (KR); Jinsu Nam, ChungCheongNam-Do (KR); Kyungwook Park, ChungCheongNam-Do (KR); Jaeyoung Choi, ChungCheongNam-Do (KR)

(73) Assignee: SAMSUNG CORNING PRECISION MATERIALS CO., LTD., Gyeongsangbuk-do (KR)

(21) Appl. No.: 13/595,037

(22) Filed: Aug. 27, 2012

(30) Foreign Application Priority Data
Aug. 31, 2011 (KR) 10-2011-0087957

(51) Int. Cl. C03B 27/012

(52) U.S. Cl. 65/114; 65/349; 65/350; 65/182.2

(57) ABSTRACT

A method of tempering glass and an apparatus for tempering glass, in which a heater is used and high frequency is generated. The method includes a heating step of heating a piece of glass using a heater and a high frequency generator and a cooling step of cooling the piece of glass by quenching.

### CROSS REFERENCE TO RELATED APPLICATION

The present application claims priority from Korean Patent Application Number 10-2011-0087957 filed on Aug. 31, 2011, the entire contents of which application are incorporated herein for all purposes by this reference.

### BACKGROUND OF THE INVENTION

1. Field of the Invention

The present invention relates to a method of tempering glass and an apparatus for tempering glass, and more particularly, to a method of tempering glass and an apparatus for tempering glass, in which a heater is used and high frequency is generated.

2. Description of Related Art

The use of glass materials is rapidly increasing in a variety of industrial fields, including photovoltaic cell covers; flat displays such as thin film transistor-liquid crystal displays (TFT-LCDs), organic electroluminescent (EL) displays; covers for a variety of mobile electronics; or the like.

Such glass materials are required to have a light weight and a thin profile, and it is therefore necessary to ensure longevity owing to the characteristics of glass materials having great brittleness.

Studies on a variety of tempering methods are underway in order to ensure the longevity of glass.

Glass tempering technologies of the related art include chemical tempering in which ions are exchanged between the surface of a piece of glass and a water solution (molten salt) and thermal tempering in which a piece of glass is heat-treated.

However, chemical tempering has drawbacks in that its value of use is unsatisfactory in terms of the process time required for ion exchange between the piece of glass and the water solution, the size of the piece of glass, the recycling of the water solution (pollution and concentration control), and the like.

In addition, thermal tempering of the related art involves quenching after raising temperature while moving a glass plate in a hot horizontal furnace. However, since the glass stays inside a hot tempering furnace for a limited time and the temperature of the piece of glass starts to rise with the surface thereof, the ability to homogenize the temperatures of the inner and outer parts of the piece of glass is limited. In addition, the minimum thickness of the piece of glass that can be tempered is 3.2t, which is problematic.

Accordingly, in order to overcome the foregoing problems, an air convection system and a new quenching technology (water mist, control over the flow rate of compressed air, and the like) for promoting uniform heating are introduced. In addition, an improvement in a transferring method (air floating) prevents glass from deforming (roller waves, warping, and the like) even if the glass is overheated. Therefore, a quenching start temperature higher than those of the existing technologies is obtained.

However, even with such methods, the minimum thickness of a piece of glass that can be tempered is 2.8t. This consequently limits the ability to reduce the weight and thickness of tempered glass, which is problematic.

Furthermore, regardless of the foregoing improvements in tempering technologies, according to such tempering technologies of the related art using convection and radiative, a piece of glass starts to be heated with the surface thereof. Therefore, the difference between the inner and outer parts of the piece of glass that can be obtained in quenching is limited. In particular, the temperature of the outer part is higher than the temperature of the inner part, which is disadvantageous in realizing surface compressive stress for tempering of the piece of glass.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a piece of glass that has a great amount of forming stress after having been tempered by controlling the temperatures of inner and outer parts of the glass.

In an aspect of the present invention, provided is a method of tempering glass. The method includes a heating step of heating a piece of glass using a heater and a high frequency generator and a cooling step of cooling the piece of glass by quenching.

In an exemplary embodiment, the heating step may include a first heating step of heating the piece of glass using the first heater and a second heating step of heating the piece of glass that is heated by the first heater using the second heater and the high frequency generator.

In an exemplary embodiment, the first heating step may heat the piece of glass at a surface temperature ranging from 300° C. to 800° C., and the second heating step may heat the piece of glass at a surface temperature ranging from 350° C. to 850° C.

In an exemplary embodiment, in the piece of glass which has been heated in the heating step, the temperature of the inner part of the piece of glass may be higher than or equal to the temperature of the outer part of the piece of glass.

In an exemplary embodiment, the thickness of the piece of glass may 2.8t or less.

In an exemplary embodiment, the high frequency generator may generate high frequency ranging from 0.98 GHz to 6.0 GHz. It is preferred that the high frequency generator generate high frequency ranging from 2.4 GHz to 5.8 GHz.

In an exemplary embodiment, the cooling step may include quenching the piece of glass using air, water mist and a cool roller.

In another aspect of the present invention, provided is an apparatus for tempering glass. The apparatus includes a transfer unit for transferring a piece of glass; a heating unit for heating the piece of glass, the heating unit comprising a heater and a high frequency generator; and a cooling unit for quenching the piece of glass heated by the heating unit.

In an exemplary embodiment, the heating unit may include a preheating furnace for heating the piece of glass using a first heater and a main heating furnace for heating the piece of glass using a second heater and the high frequency generator.

In an exemplary embodiment, the transfer unit may include an air supplier for providing an air cushion to an undersurface of the piece of glass while transferring the piece of glass in the heating unit.

According to embodiments of the present invention, it is possible to ensure that the difference between the temperature of the inner part and the temperature of the outer part of the piece of glass be positive during the process in which the piece of glass is heated so that the piece of glass after having been tempered can achieve a great amount of forming stress, thereby further enhancing the strength of the piece of glass.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic flowchart depicting a method of tempering glass according to an embodiment of the invention;

FIG. 2 is a graph depicting differences in the temperatures between inner and outer parts of a piece of glass that was heated using a heater of the related art;

FIG. 3 is a graph depicting variation in the temperatures of inner and outer parts of a piece of glass when the temperature of the outer part of the piece of glass has reached a predetermined temperature;

FIG. 4 is a graph depicting variation in the temperatures of inner and outer parts of a piece of glass depending on high frequency output after the piece of glass was heated so that the temperatures of the inner and outer parts thereof became 600° C.;

FIG. 5 is a graph depicting the temperatures of inner and outer parts of a piece of glass that were controlled by adjusting high frequency output and operation;

FIG. 6 is a graph depicting differences in the temperatures between inner and outer parts of a piece of glass depending on initial temperatures after high-frequency heating;

FIG. 7 is a graph depicting variation in the temperature of an inner part of a piece of glass depending on the thickness of the piece of glass;

FIG. 8 is a schematic configuration view depicting an apparatus for tempering glass according to an embodiment of the invention; and

FIG. 9 is a schematic configuration view depicting a heater that is a component of the apparatus for tempering glass according to another embodiment of the invention.

### DETAILED DESCRIPTION OF THE INVENTION

Reference will now be made in detail to a method of tempering glass and an apparatus for tempering glass according to the present invention, various embodiments of which are illustrated in the accompanying drawings and described below, so that a person having ordinary skill in the art to which the present invention relates can easily put the present invention into practice.

Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

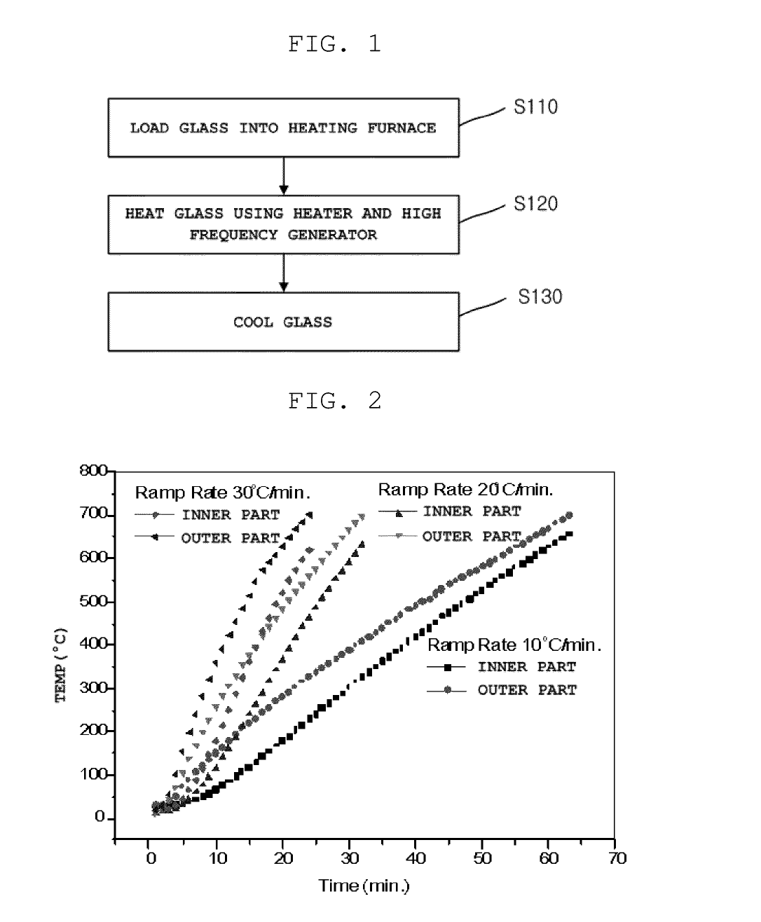

FIG. 1 is a schematic flowchart depicting a method of tempering glass according to an embodiment of the invention.

Referring to FIG. 1, the method of tempering glass according to an embodiment of the invention may include a transferring step S110, a heating step S120 and a cooling step S130.

In order to temper a piece of glass, first, at S110, the piece of glass that is to be tempered is transferred to a heating unit.

The piece of glass may be a thin plate of glass having a thickness of 2.8t or less.

Afterwards, at S120, the piece of glass that is loaded into the heating unit is heated using a heater and a high frequency generator.

The heater heats the piece of glass from the outer part to the inner part thereof by generating heat due to electrical resistance, and the high frequency generator heats both the inner and outer parts of the piece of glass by vibrating ions inside the piece of glass by generating high frequency.

Here, the high frequency generator generates high frequency in the range from 0.98 GHz to 6.0 GHz, preferably, from 2.4 GHz to 5.8 GHz.

The difference between the inner and outer parts of the piece of glass that is being heated can be controlled by adjusting an atmospheric temperature during heating, high frequency output, the volume of the piece of glass, and the like. It is preferred that the piece of glass be heated until the temperature of the inner part of the piece of glass is the same as or greater than the temperature of the outer part of the piece of glass.

In general, a piece of tempered glass refers to a piece of glass of which the mechanical strength is increased by inducing stress to the piece of glass. Forming stress in the piece of glass after having been tempered is expressed by the following formula:

$$σ = \frac{α E}{1 - v} \times \frac{2}{3} \times Δ T ,$$

where σ is the stress of the piece of glass after having been tempered, ν is Poisson's ratio, α is a coefficient of thermal expansion, E is Young's modulus, and ΔT (ΔT_{heating}+ΔT_{quenching}) is the temperature of an inner part of the piece of glass—the temperature of an outer part of the piece of glass.

Heating using a heater of the related art (ΔT_{heating}) is a type of heating using radiation/convection/conduction, in which the difference between the temperatures of the inner and outer parts of the piece of glass has a negative value. In contrast, quenching (ΔT_{quenching}) has a problem in that the difference between the temperatures of the inner and outer parts of the piece of glass has a positive value so that stress that can be obtained after tempering decreases.

Accordingly, the present invention heats the piece of glass using the heater and the high frequency generator.

Heating using the heater starts with the outer part (surface) of the piece of glass, and heating using the high frequency generator is carried out across the inner and outer parts (volume) of the piece of glass.

The piece of glass is heated using the heater and the high frequency generator, whereas the temperature atmosphere of the heating unit depends only on the heating temperature of the heater, so that the temperature of the heating unit becomes lower than the temperature of the piece of glass. This consequently forms a temperature gradient in which the temperature of the surface of the piece of glass is lower than the temperature of the inner part of the piece of glass because the surface of the piece of glass is cooled by the air.

Since the difference between the temperatures of the inner and outer parts of the piece of glass ΔT-heating has a positive value, the piece of glass after having been tempered can obtain great forming stress. Therefore, it is possible to further enhance the strength of the piece of glass.

The heating step for the piece of glass that is loaded into the heating unit can include a first heating step in which a first heater is used and a second heating step in which a second heater and a high frequency generator are used.

Since the piece of glass is heated using the first heater and is then heated using the second heater and the high frequency generator, it is possible to increase the temperature of the inner part of the piece of glass due to high frequency heating while reducing the problems of difficult temperature control and localized heating which would otherwise occur when the piece of glass is heated by the high frequency.

Specifically, the high frequency heating may cause a phenomenon of thermal runway that is attributable to a nonlinear increase in the temperature of the piece of glass and a phenomenon of localized heating at a point on the piece of glass in which high frequency is absorbed well.

However, since the high frequency heating is performed after the piece of glass is heated due to the frictional heating using the heater such that its temperature becomes a predetermined temperature or higher at which the thermal runway would otherwise occur due to the high frequency heating, it is possible to prevent the thermal runway of the piece of glass and alleviate the localized heating of the piece of glass.

Here, at the first heating step, the piece of glass will be heated at a temperature that is 300° C. or higher and does not exceed a temperature at which the piece of glass is heated at the second heating step.

Even when the heating temperature at the first heating step and the heating temperature at the second heating step are the same, the temperature of the inner part of the piece of glass at the second heating step is higher than the temperature of the inner part of the piece of glass at the first heating step because the second heating step includes high frequency heating.

It is preferred that the first heating step heat the piece of glass at a temperature ranging from 300° C. to 800° C. and that the second heating step heat the piece of glass at a temperature ranging from 350° C. to 850° C.

Finally, at S130, the piece of heated glass is cooled by quenching, so that tempering of the piece of glass is completed.

Here, quenching may be carried out by blowing cooled compressed air and water mist onto the heated piece of glass and transferring the heated piece of glass on a cool roller.

FIG. 2 to FIG. 7 are graphs depicting effects on a piece of glass caused by high frequency heating according to the invention.

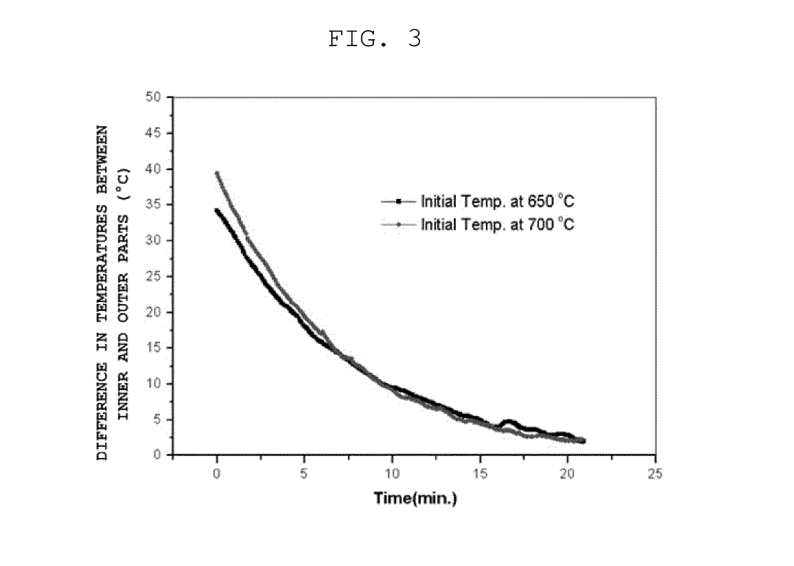

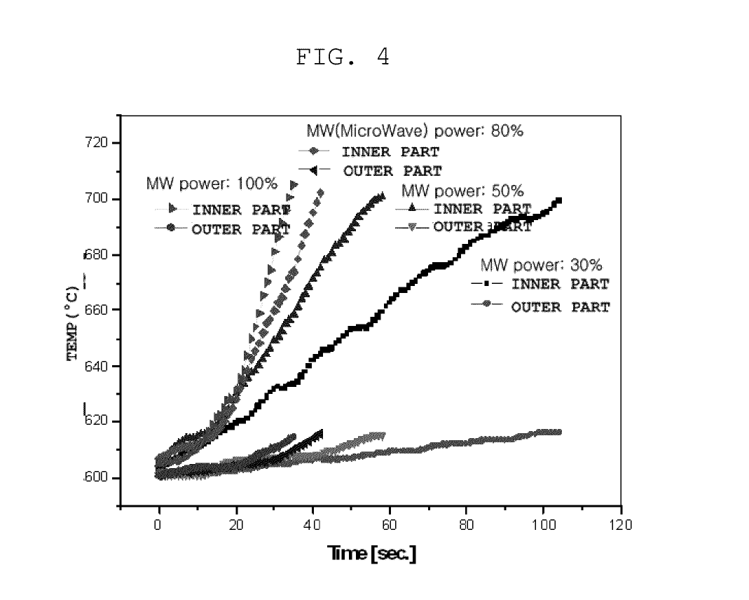

FIG. 2 is a graph depicting differences in the temperatures between inner and outer parts of a piece of glass that was heated using a heater of the related art, and FIG. 3 is a graph depicting variation in the temperatures of inner and outer parts of a piece of glass when the temperature of the outer part of the piece of glass has reached a predetermined temperature.

Referring to FIG. 2, it can be appreciated that the temperature of the outer part of the piece of glass is higher than the temperature of the inner part of the piece of glass when the piece of glass was heated using the heater of the related art. It is therefore apparent, as described above, that the use of the heater of the related art has a disadvantageous effect on the formation of stress which strengthens the piece of glass.

In addition, referring to FIG. 3, it takes a long time before the temperature of the outer part of the piece of glass becomes the same as the temperature of inner part of the piece of glass. It is difficult to adjust/maintain the temperatures of the inner and outer parts of the piece of glass to be uniform within a predetermined process time using the method of the related art. That is, the method of imparting the piece of glass with high forming strength by homogenizing the temperatures of the inner and outer parts of the piece of glass after the piece of glass is heated using the heater of the related art is rarely applicable to an in-line process.

FIG. 4 is a graph depicting variation in the temperatures of inner and outer parts of a piece of glass depending on high frequency output after the temperatures of the inner and outer parts of the piece of glass are heated to 600° C.

Referring to FIG. 4, it can be appreciated that the inner part of the piece of glass was heated first when the piece of glass was heated using high frequency. Accordingly, the piece of glass after having been tempered can have large compressive stress, as described above.

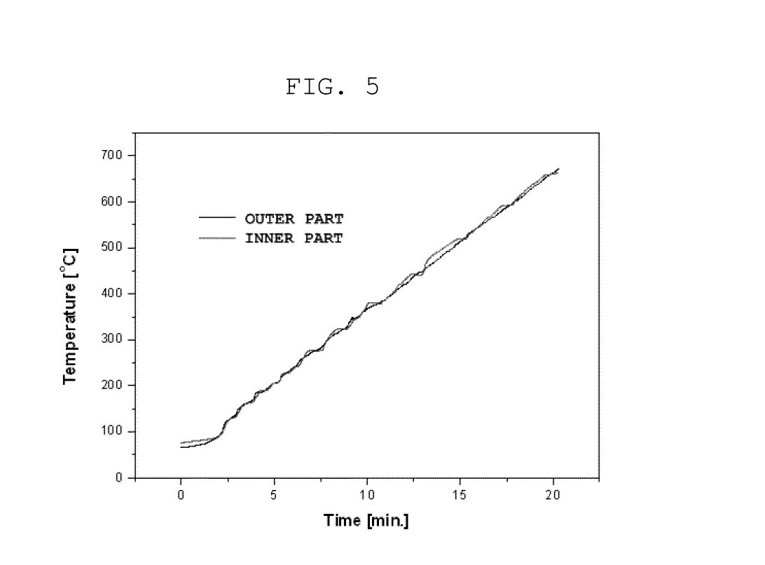

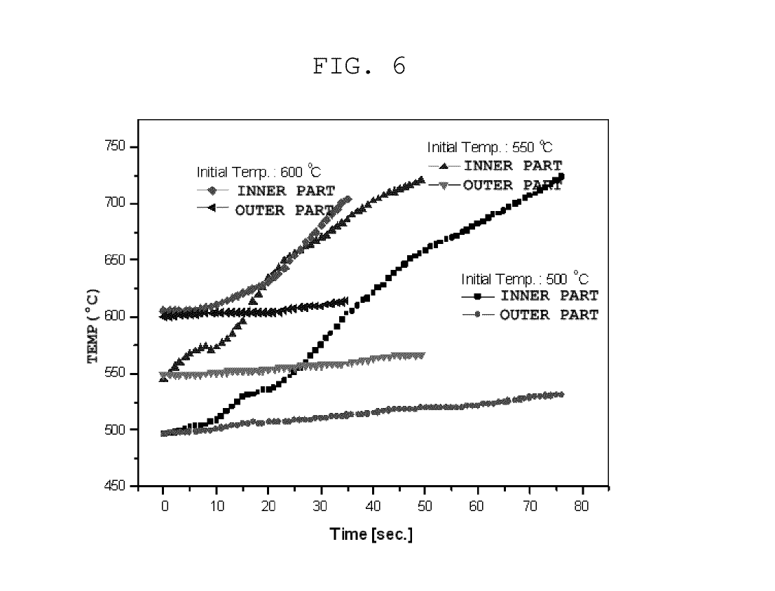

FIG. 5 is a graph depicting the temperatures of inner and outer parts of a piece of glass that are controlled by adjusting the output and operation of high frequency. That is, the invention makes it possible to efficiently control the stress of the piece of glass after having been tempered by adjusting the temperatures of the inner and outer parts of the piece of glass due to control over high frequency output.

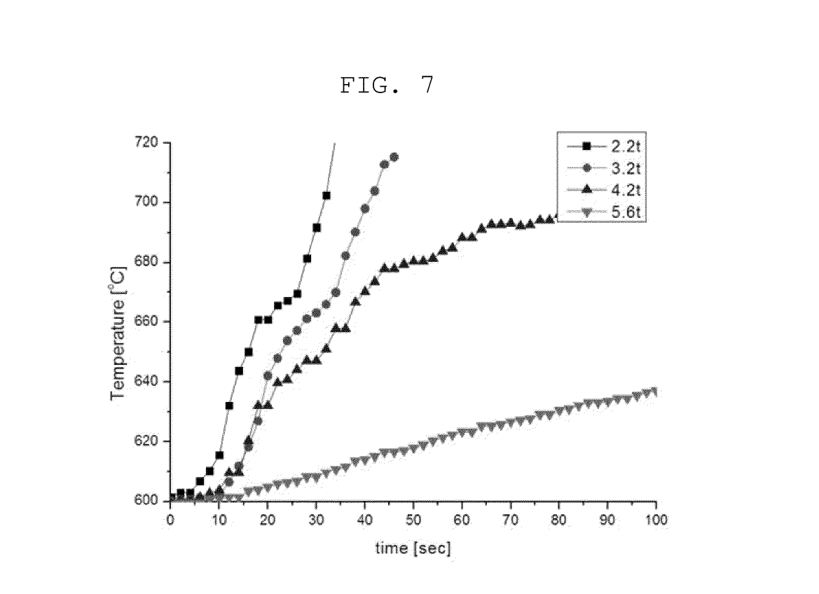

FIG. 6 is a graph depicting differences in the temperatures between inner and outer parts of a piece of glass depending on initial temperatures after high-frequency heating.

Referring to FIG. 6, the temperatures of the inner and outer parts of the piece of glass depending on the initial temperatures did not vary greatly. It is therefore apparent that it is easy to control the temperature of the piece of glass at a predetermined temperature or higher.

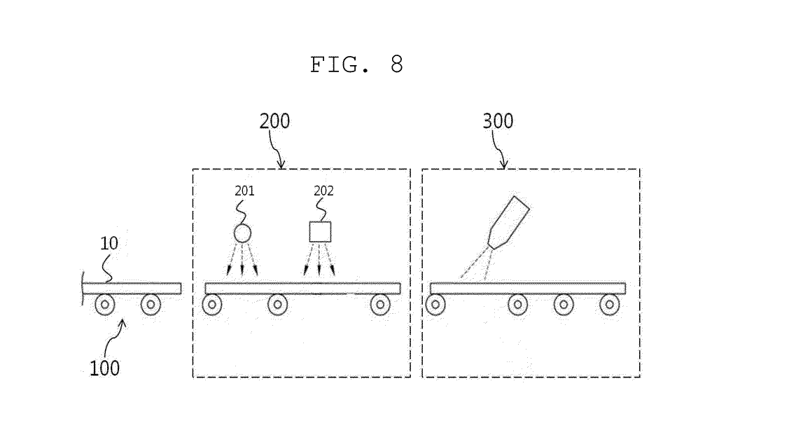

FIG. 7 is a graph depicting variation in the temperature of an inner part of a piece of glass depending on the thickness of the piece of glass.

Referring to FIG. 7, it can be appreciated that the rate at which the temperature of the inner part of the piece of glass rises is increased with the decrease in the thickness of the piece of glass. That is, it shows that it is possible to not only heat even a thin plate of glass using high frequency, but also achieve high productivity by reducing process time for tempering.

FIG. 8 is a schematic configuration view depicting an apparatus for tempering glass according to another embodiment of the invention.

Referring to FIG. 8, the apparatus for tempering glass includes a transferring section 100, a heating section 200 and a cooling section 300.

The transferring section 100 transfers a piece of glass 10 that is to be tempered. Although FIG. 8 illustrates that the transferring unit includes a roller, the present invention is not limited thereto. Rather, the transferring section may be realized such that the surface of the glass is transferred without contacts.

In addition, the transferring unit 100 may include an air supplier (not shown) which serves to prevent the piece of glass 10 from being damaged when the piece of glass 10 is transferred in the heating unit 200.

When the piece of glass 10 is transferred using a roller in a hot atmosphere of the heating unit 200, some problems may occur in the process in which the surface of the piece of glass is brought contact with the surface of the roller. The problems of the piece of glass may include, but are not limited to, warping, sagging and surface damage, in which scratches or waved recesses (namely, roller waves) are formed in the surface of the piece of glass.

Accordingly, the piece of glass is brought into contact with the roller via the air supplier (not shown) and an air cushion is formed by blowing air onto the undersurface of the piece of glass that would otherwise warp or sag due to heat. In this fashion, it is possible to support the piece of glass that would otherwise warp or sag and to prevent the surface of the piece of glass from being damaged. Here, the air that is blown onto the piece of glass may be hot air.

The heating unit 200 includes a heater 201 for heating the piece of glass and a high frequency generator 202. Although FIG. 8 shows one heater and one high frequency generator, a plurality of heaters and a plurality of high frequency generators corresponding to the size of the piece of glass may be provided. In this case, it is preferred that the heaters and the high frequency generators be disposed such that they alternate with each other.

As described above, the heater 201 heats the piece of glass 10 from the outer part to the inner part thereof by generating heat due to electrical resistance, and the high frequency generator 202 heats both the inner and outer parts of the piece of glass 10 due to frictional heat by vibrating ions inside the piece of glass 10 by generating high frequency.

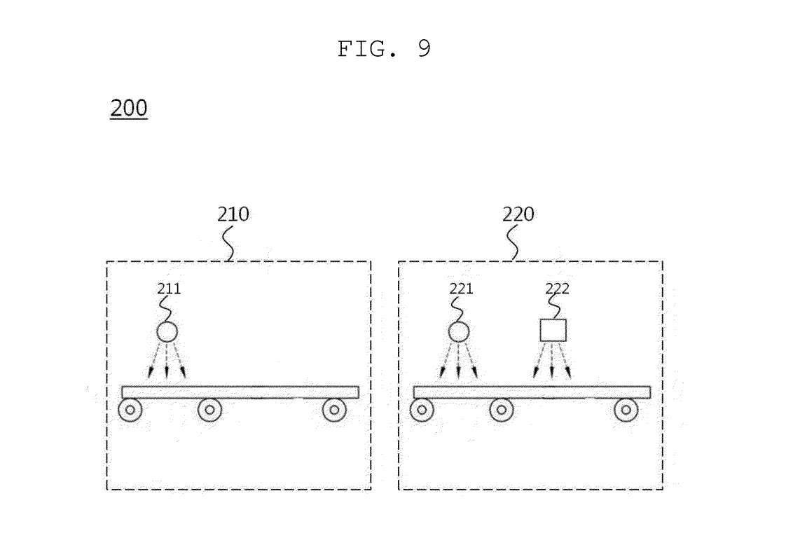

FIG. 9 is a schematic configuration view depicting a heater that is a component of the apparatus for tempering glass according to another embodiment of the invention.

As shown in FIG. 9, the heating unit 200 may include a preheating furnace 210 which heats the piece of glass 10 using the first heater 211 and a main heating furnace 220 which heats the piece of glass using the second heater 221 and the high frequency generator 222.

In some embodiments, the first heater and the second heater may be the same heater. For example, in an apparatus for tempering glass in which the piece of glass 10 is heated while temporarily staying in the heating unit or the heater moves along the piece of glass, the piece of glass may be preheated and heated using the same heater.

The cooling unit 300 quenches the piece of glass 10 that has been heated by the heating unit 200.

Although FIG. 9 shows one first heater, one second heater and one high frequency generator, a plurality of first heaters, a plurality of second heaters and a plurality of high frequency generators corresponding to the size of the piece of glass may be provided.

The foregoing descriptions of specific exemplary embodiments of the present invention have been presented with respect to the certain embodiments and drawings. They are not intended to be exhaustive or to limit the invention to the precise forms disclosed, and obviously many modifications and variations are possible for a person having ordinary skill in the art in light of the above teachings.

It is intended therefore that the scope of the invention not be limited to the foregoing embodiments, but be defined by the Claims appended hereto and their equivalents.

What is claimed is:

1. A method of tempering glass, comprising the steps of:
heating a piece of glass using a heater and a high frequency generator; and
cooling the piece of glass by quenching.

2. The method of claim 1, wherein
the heater comprises a first heater and a second heater, and
the heating step comprises:
heating the glass using the first heater; and
heating the piece of glass that is heated by the first heater using the second heater and the high frequency generator.

3. The method of claim 2, wherein the high frequency generator generates high frequency ranging from 0.98 GHz to 6.0 GHz.

4. The method of claim 3, wherein the high frequency generator generates high frequency ranging from 2.4 GHz to 5.8 GHz.

5. The method of claim 2, wherein
heating the piece of glass using the first heater comprises heating the piece of glass at a temperature ranging from 300° C. to 800° C., and
heating the piece of glass using the second heater and the high frequency generator comprises heating the piece of glass at a temperature ranging from 350° C. to 850° C.

6. The method of claim 1, wherein a temperature of an inner part of the piece of glass which has been heated in the heating step is higher than or equal to a temperature of an outer part of the piece of glass which has been heated in the heating step.

7. The method of claim 1, wherein a thickness of the piece of glass is 2.8 mm or less.

8. The method of claim 1, wherein the cooling step comprises quenching the piece of glass using air, water mist and a cool roller.

9. An apparatus for tempering glass, comprising:
a transfer unit for transferring a piece of glass;
a heating unit for heating the piece of glass, the heating unit comprising a heater and a high frequency generator; and
a cooling unit for quenching the piece of glass heated by the heating unit.

10. The apparatus of claim 9, wherein
the heater comprises a first heater and a second heater, and
the heating unit heats the piece of glass using the first heater, and then heats the piece of glass using the second heater and the high frequency generator.

11. The apparatus of claim 9, wherein the transfer unit comprises an air supplier for providing an air cushion to an undersurface of the piece of glass while transferring the piece of glass in the heating unit.
